(19) United States
(12) Patent Application Publication
(10) Pub. No.: US 2002/0067594 A1
(43) Pub. Date: Jun. 6, 2002

(54) Control device and a notebook PC comprising the same

(75) Inventors: Mao-Sung Huang, His-Hu Chen (TW); Hsin-Yung Lu, Shang-Kuan Li (TW)

Correspondence Address: Richard P. Berg, Esq., c/o LADAS & PARRY, Suite 2100, 5670 Wilshire Boulevard, Los Angeles, CA, 90036-5679, US

(73) Assignee: Darfon Electronics Corp.

(21) Appl. No.: 10/010,518

(22) Filed: Nov. 13, 2001

(30) Foreign Application Priority Data
Dec. 1, 2000 (TW) 89220910

(51) Int. Cl. G06F 1/16

(52) U.S. Cl. 361/686

(57) ABSTRACT

A control device, which is comprised of a sensor board that comprises a first through hole; at least one first sensor situated on the sensor board, provided to generate an inductive signal according to a distortion of the sensor board; a control post that passes through the first through hole; and a stopper, connected to one end of the post, and further connected to the sensor board, thus connecting the post to the sensor board. In this manner, the length of the control post can be increased without adding to the thickness of the notebook PC. Corresponding to applied force, the control post may produce larger torque, increasing the sensitivity of the control device.

### BACKGROUND OF THE INVENTION

1. Field of the Invention

The present invention relates to a control device, particularly relates to a control device of superior sensitivity and a notebook PC comprising the same.

2. Description of the Prior Art

Laptop or notebook PCs are frequently equipped with mechanical control devices. Generally, the control device has a control post disposed between the keys of a keyboard, providing additional functions for users. For example, in word processing, a control post could be used to provide fast scrolling, saving edit-time for the user. FIG. 1 shows a conventional notebook PC with a control device. The control device comprises a sensor board, and the sensor board is provided with sensors coupling to the main board of the PC. Each of the sensors is generally a strain gauge, which can be regarded as generating variable resistance, the impedance of which changes according to the distortion of the sensor board. By applying external force to the control post, voltage transmitted from the sensor board to the main board is varied, and the user is able to input signals to the main board by manipulating the control post.

Basically, the stronger an applied force is, the greater the resultant distortion of the sensor board will be. Meanwhile, a greater resultant distortion of the sensor board would produce a larger variation of the resistance of the strain gauge. FIG. 2 which shows a control device provided in U.S. Pat. No. 5,835,977. In accordance to an external force f, the sustained force F applied to the sensor board S is related to the length L of the control post. A longer control post would result in a larger torque (or said sustained force F) against the sensor board S, and the sensor board S would consequently reveal a greater distortion, and the sensor R would be more sensitive to the external force. In other words, a longer control post would create a more sensitive control device.

As to the prior arts, because of constraints on the thickness of notebook PCs, the length of control posts is limited. However, the notebook PC comprising a control device according to the present invention provides another method for increasing the length of the control post.

### SUMMARY OF THE INVENTION

The first aspect of the present invention is a control device, comprising: a sensor board, having a first through hole; at least one first sensor, disposing on the sensor board; a post, having a first end and a second end; and a stopper, connecting to the second end of the post; wherein the post is extended through the first through hole by the first end, the stopper is connected to the sensor board.

The first sensor comprises a strain gauge having a resistance that varies according to the distortion of the sensor board.

The control device of the present invention further comprises at least one second sensor, wherein the first and the second sensors are perpendicularly disposed to each other, thereby detecting the distortion of the sensor board in various orientations.

The first sensor is disposed around the periphery of an assembly region, where the sensor board and the stopper are connected. The first sensor is further extended through a gap between the sensor board and the stopper.

The second aspect of the present invention is a control device, comprising: a sensor board, having a first through hole; a spacer, having a second through hole; at least one first sensor, disposed on the sensor board; a post, having a first end and a second end; and a stopper, disposed on the second end of the post; wherein the post is passed through the first and the second through holes by the first end, and the spacer is disposed between the stopper and the sensor board.

The first sensor comprises a strain gauge having a resistance that varies according to a distortion of the sensor board.

The control device of the present invention further comprises at least one second sensor, wherein the first and the second sensors are perpendicularly disposed to each other, thereby detecting the distortion of the sensor board in various orientations.

The first sensor is disposed around the periphery of an assembly region, where the sensor board, the spacer, and the stopper are connected. The first sensor is further extended through a gap between the sensor board and the spacer.

The third aspect of the present invention is a notebook PC, comprising: a main body, having a keyboard device and a base inside, wherein the keyboard device comprises a control post region, and the control post region is comprised of a control device, wherein the control device has: a sensor board, having a first through hole; a spacer, having a second through hole; at least one first sensor, disposing on the sensor board; a post, having a first end and a second end passing through the first and the second through holes, and extending outward from the control post region; and a stopper, connecting to the second end of the post, wherein the post is passed through the first and the second through hole by the first end, and the spacer is connected between the stopper and the sensor board; wherein the control device is disposed on the base, the post is extended outwardly the keyboard device.

The first sensor comprises a strain gauge having a resistance that varies according to a distortion of the sensor board.

The notebook PC of the present invention further comprises at least one second sensor, wherein the first and the second sensors are perpendicularly disposed to each other, thereby detecting the distortion of the sensor board in various orientations.

In the notebook PC of the present invention, the first sensor is disposed around the periphery of an assembly region, where the sensor board and the stopper are connected. Wherein, the first sensor is further extended through a gap between the sensor board and the stopper.

The base comprises an opening, connecting the sensor board to the base with the stopper disposed in the opening. Alternatively, the sensor board may be connected to the base with the post extending outward from the opening.

The fourth aspect of the present invention is a notebook PC, comprising: a main body, having a keyboard device and a base inside, wherein the keyboard device comprises a control post region, and the control post region is comprised of a control device, wherein the control device has: a sensor board, having a first through hole; a spacer, having a second through hole; at least one first sensor, disposing on the sensor board; a post, having a first end and a second end passing through the first and the second through holes, and extending outward from the control post region; and a stopper, connecting to the second end of the post, wherein the post is passed through the first and the second through hole by the first end, and the spacer is connected between the stopper and the sensor board; wherein the control device is disposed on the base, the post is extended outwardly the keyboard device.

The first sensor comprises a strain gauge having a resistance that varies according to a distortion of the sensor board.

The notebook PC of the present invention further comprises at least one second sensor, wherein the first and the second sensors are perpendicularly disposed to each other, whereby detecting the distortion of the sensor board in various orientations. Wherein, the first sensor is disposed around the periphery of an assembly region, whereabouts the sensor board, the spacer, and the stopper are connected. In addition, the first sensor is further extended through a gap between the sensor board and the spacer.

### BRIEF DESCRIPTION OF THE DRAWINGS

The present invention can be fully understood from the following detailed description and preferred embodiment with reference to the accompanying drawings in which:

FIG. 1, 2 shows a conventional notebook PC comprising a control device.

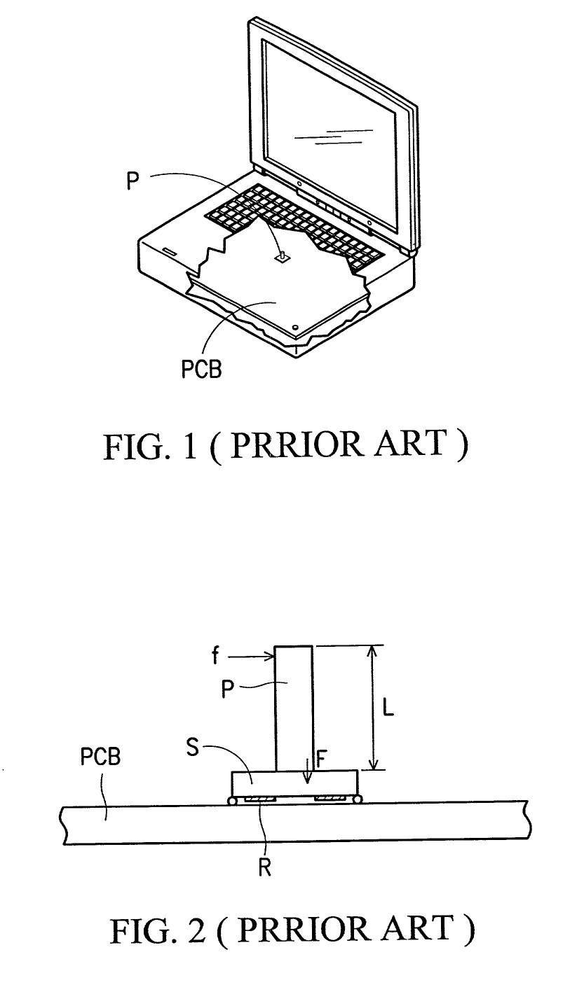

FIG. 3a, 3b show a control device according to a first embodiment of the present invention.

FIG. 3c shows an assembly for the sensor, the sensor board, the second surface, and the stopper.

FIG. 4a, 4b show a control device according to a second embodiment of the present invention.

FIG. 5 shows a control device according to a third embodiment of the present invention.

### DETAIL DESCRIPTION OF THE EMBODIMENTS

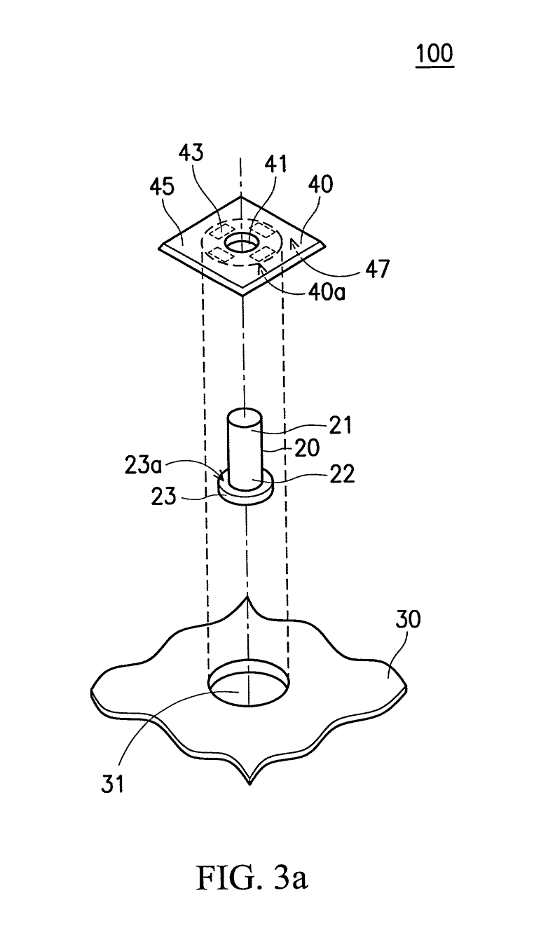

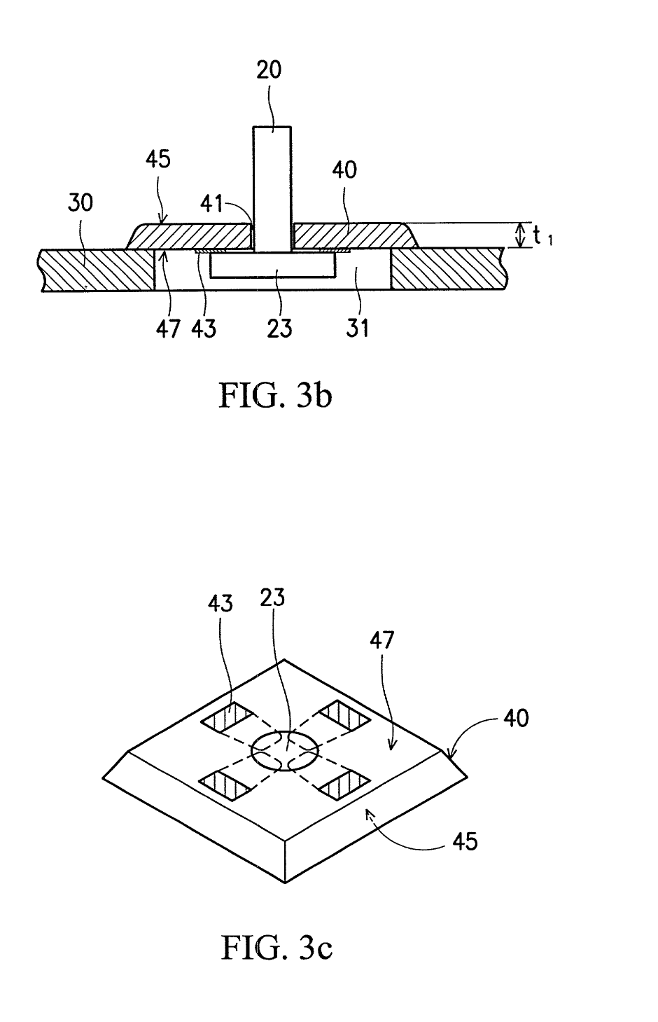

FIG. 3a is an exploded view, showing a control device 100 according to the first embodiment of the present invention. FIG. 3b is a section view, showing the control device 100. The control device may be disposed on a base, wherein the control device 10 is comprised of a post 20 and a sensor board 40.

The sensor board 40 is comprised of a first surface 45, a second surface 47, and a first through hole 41 that slightly larger than the post 20. The second surface 47 is further disposed with sensors 43. The post 20 is comprised of a first end 21 and a second end 22, and the post 20 comprises a stopper 23 at the second end 22, wherein the stopper 23 is larger than the first through hole 41 in radius, thus forming a second assembly surface 23a, which is facing the first end and surrounding the post 20. As in FIG. 3a, wherein, the post 20 passes through the first through hole 41 by the first end, and extends upward from the sensor board 40, the second assembly surface 23a of the stopper 23 is adhered to the first assembly surface 40a of the sensor board 40. There is preferably a gap between the post 20 and the first through hole 41 for a slight radial displacement of the post 20.

As shown in FIG. 3c, the sensors 43 may be placed on the second surface 47 of the sensor board 40 according to the sections of oblique lines, surrounding the periphery of an assembly section of the stopper 23 and the sensor board 40. When applying an external force to the post 20, the stopper 23 is affected to twist and distort the sensor board 40. Consequently, the sensor 43 produces a variation of the resistance thereof according to the distortions of the sensor board 40.

Moreover, as shown in FIG. 3c, the sensors 43 may be disposed according to the region surrounded by the dotted lines. The sensors 43 extend to the assembly section between the stopper 23 and the sensor board 40. Furthermore, parts of the sensors 43 may further exceed the assembly section, whereby the sensor is not only adapted to sense the distortion of the sensor board 40 according to an external force, but also a resultant pressing force applied by the stopper 23 against the sensors 43. In this manner, the control device 100 is provided with higher sensitivity.

As the control device 100 is installed in a notebook PC, it is placed on a base 30 under a keyboard device. FIG. 3b is a section view of the control device 100 of the present embodiment. The base 30 is comprised of an opening 31, wherein the size of the stopper 23 of the control device 100 is smaller than that of the opening 31 in radius, the stopper 23 at the second end 22 of the post 20 is disposed in the opening 31 of the base 30, and the sensor board 40 is placed upon the base 30. In this manner, the length of the control post 20 can be enhanced without increasing the thickness of the notebook PC. In FIGS. 2 and 3b, the control device of the present embodiment, the control post 20 may be increased by t1, which is also the thickness of the sensor board. Consequently, corresponding to the same external force, the control post 20 may result in a larger torque, and the sensitivity of the control device 100 may be increased.

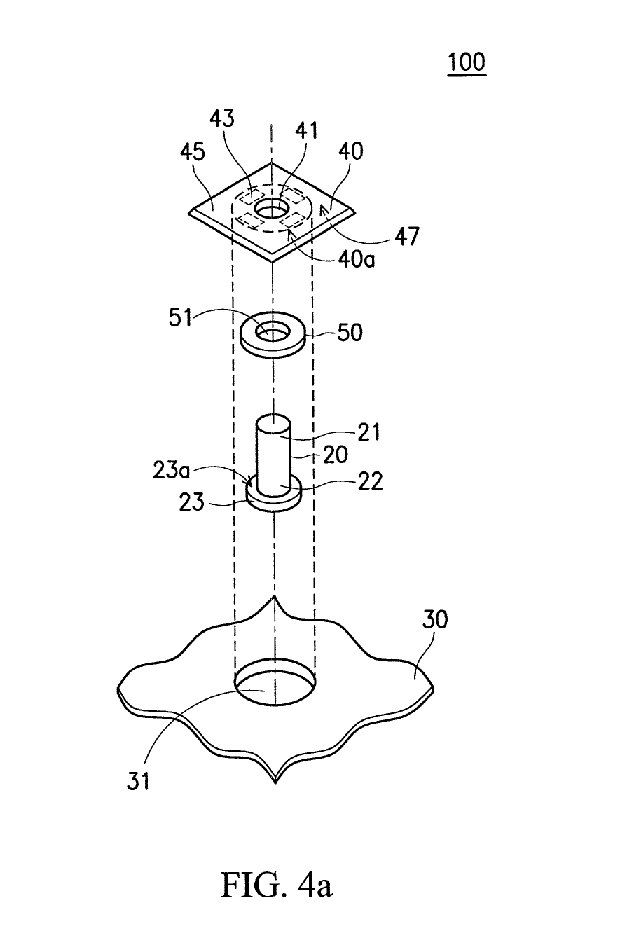

FIGS. 4a and 4b are respectively an exploded view and a section view according to a second embodiment of the present invention. Referring to the FIG. 4a, the difference between the present embodiment and the embodiment in FIG. 3a is the disposal of a spacer 50. The spacer 50 is comprised of a second through hole 51. In assembly, the post 20 is extended outward the second through hole 51 of the spacer 50 and the first through hole 41 of the sensor board 40 by the first end 21. Wherein, the second through hole 51 is slightly larger than the post 20 in radius for forming a gap between the post 20 and the second through hole 51 for a slight radial displacement of the post 20.

The sensors 43 may be placed on sensor board 40 surrounding the spacer 50. As an external force is applied to the post, the spacer 50 is forced to twist the sensor board 40, and the sensor board 40 is distorted thereby. Consequently, the sensors 43 detect the distortion of the sensor board and produce a corresponding variation of the resistance thereof.

Moreover, in FIG. 3c, the sensors 43 may be disposed according to the region surrounded by the dotted lines. Wherein, the sensors 43 extend to the assembly section between the spacer 50 and the sensor board 40. Furthermore, parts of the sensors 43 may further exceed the assembly section, whereby the sensors 43 is not only adapted to sense the distortion of the sensor board 40 according to an external force, but also a resultant pressing force applied by the spacer 50 against the sensors 43. In this manner, the control device 100 would be provided with a further higher sensitivity.

As the control device 100 is installed on a notebook PC, it is placed on a base 30 under a keyboard device. FIG. 4b is a section view of the control device 100 of the present embodiment. The base 30 is comprised of an opening 31, wherein the size of the stopper 23 and the spacer 50 of the control device 100 is smaller than that of the opening 31 in radius, the stopper 23 and the spacer 50 are disposed in the opening 31 of the base 30, and the sensor board 40 is placed upon the base 30. In this manner, the length of the control post 20 can be increased without adding to the thickness of the notebook PC. Refer to FIGS. 2 and 4b, for the control device of this second embodiment, the control post 20 may be increased by t1+t2, wherein t1 and t2 are, respectively, the thickness of the sensor board 40 and that of the spacer 50. Consequently, corresponding to the same external force, the control post 20 may result in a larger torque, and the sensitivity of the control device 100 may be increased.

In the above-mentioned embodiments, the sensors 43 may be alternatively placed on the first surface 45 of the sensor board 40 with the through hole 41 surrounded (not shown). This is a simple replacement, and the detail descriptions thereof are omitted.

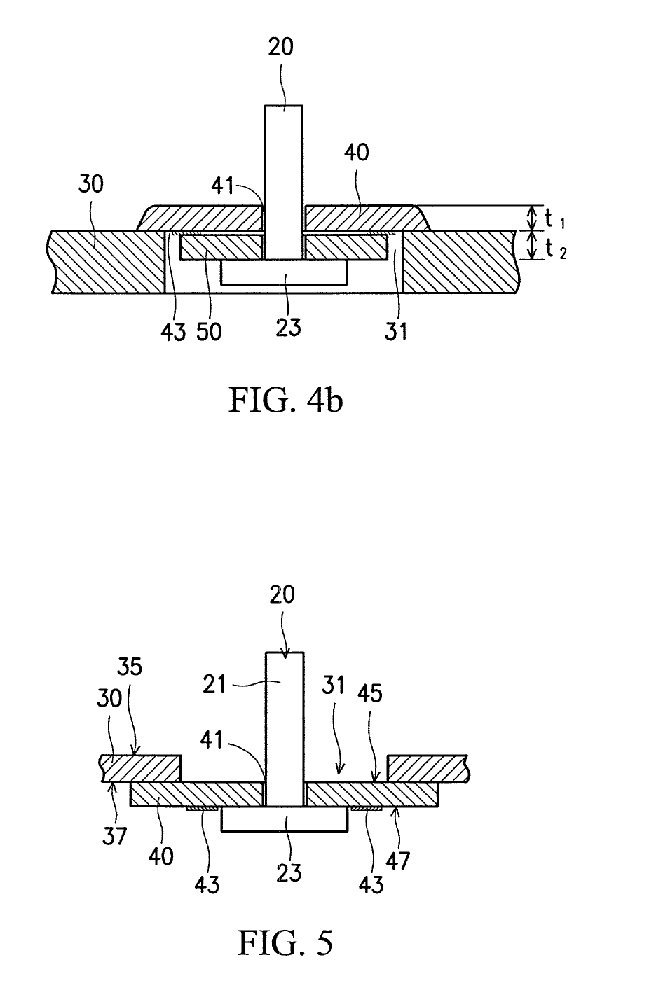

FIG. 5 is a third embodiment of the present invention, showing another assembling method for the control device 100 and the base 30. In assembly, the sensor board 40 is placed under the base 30, whereby the stopper 23 and the sensor board 40 are disposed under the sensor board 40 together. The base 30 is comprised of a first surface 35 and a second surface 37, wherein the post 20 passes through the first through hole 41 by the first end 21, and stretches upward from the first surface 35 of the base 30. The first surface 45 of the sensor board 40 is adherent to the second surface 37 of the base 30, and the sensors 43 are placed on the second surface 47 of the sensor board 40 with the first through hole 41 surrounded. In this manner, the maximum increased length of the post 20 may be up to the sum of the thickness of the base 30 and the thickness of the sensor board. The sensors 43 may be further extended to the assembly region between the sensor board 40 and the stopper 23 (not shown), whereby the control device 100 is provided with higher sensitivity. Additionally, the sensors 43 may be placed on the first surface 45 of the sensor board 40 with the through hole 41, and also, the sensors 43 may be extended to the assembly region between the sensor board 40 and the base 30 for higher sensitivity of the control device 100.

While the invention has been described with reference to a preferred embodiment, the description is not intended to be construed in a limiting sense. It is therefore contemplated that the appended claims will cover any such modifications or embodiments as may fall within the scope of the invention defined by the following claims and their equivalents.

What is claimed is:

1. A control device, comprising:
a sensor board, having a first through hole;
at least one first sensor, disposing on the sensor board;
a post, having a first end and a second end; and
a stopper, connecting to the second end of the post;
wherein the post is extended through the first through hole by the first end, the stopper is connected to the sensor board.

2. The control device of claim 1, wherein the first sensor comprises a strain gauge having a resistance that varies according to a distortion of the sensor board.

3. The control device of claim 2, further comprising at least one second sensor, wherein the first and the second sensors are perpendicularly disposed to each other, thereby detecting the distortion of the sensor board in various orientations.

4. The control device of claim 1, wherein the first sensor is disposed around the periphery of an assembly region, where the sensor board and the stopper are connected.

5. The control device of claim 4, wherein the first sensor is further extended through a gap between the sensor board and the stopper.

6. A control device, comprising:
a sensor board, having a first through hole;
a spacer, having a second through hole;
at least one first sensor, disposed on the sensor board;
a post, having a first end and a second end; and
a stopper, disposed on the second end of the post;
wherein the post is passed through the first and the second through holes by the first end, and the spacer is disposed between the stopper and the sensor board.

7. The control device of claim 6, wherein the first sensor comprises a strain gauge having a resistance that varies according to a distortion of the sensor board.

8. The control device of claim 7, further comprising at least one second sensor, wherein the first and the second sensors are perpendicularly disposed to each other, thereby detecting the distortion of the sensor board in various orientations.

9. The control device of claim 6, wherein the first sensor is disposed around the periphery of an assembly region where the sensor board and the spacer are connected.

10. The control device of claim 9, wherein the first sensor is further extended through a gap between the sensor board and the spacer.

11. A notebook PC, comprising:
a main body, having a keyboard device and a base inside, wherein the keyboard device has a control post region, and the control post region is comprised of a control device, wherein the control device comprises:
a sensor board, having a first through hole;
at least one first sensor, disposed on the sensor board;
a post, having a first end and a second end, and extending outward from the control post region; and
a stopper, connecting to the second end of the post, wherein the post is passed through the first through hole by the first end, and the stopper is connected to the sensor board;
wherein the control device is connected to the base.

12. The notebook PC of claim 11, further comprising at least one second sensor, wherein the first and the second sensors are perpendicularly disposed to each other, thereby detecting a distortion of the sensor board in various orientations.

13. The notebook PC of claim 11, wherein the first sensor is disposed around the periphery of an assembly region, where the sensor board and the stopper are connected.

14. The notebook PC of claim 13, wherein the first sensor is further extended through a gap between the sensor board and the stopper.

15. The notebook PC of claim 11, wherein the base comprises an opening, connecting the sensor board to the base with the stopper disposed in the opening.

16. The notebook PC of claim 11, wherein the base comprises an opening, and the sensor board is connected to the base with the post extending outward from the opening.

17. A notebook PC, comprising:
a main body, having a keyboard device and a base inside, wherein the keyboard device comprises a control post region, and the control post region is comprised of a control device, wherein the control device has:
a sensor board, having a first through hole;
a spacer, having a second through hole;
at least one first sensor, disposing on the sensor board;
a post, having a first end and a second end passing through the first and the second through holes, and extending outward from the control post region; and
a stopper, connecting to the second end of the post, wherein the post is passed through the first and the second through hole by the first end, and the spacer is connected between the stopper and the sensor board;
wherein the control device is disposed on the base, the post is extended outwardly the keyboard device.

18. The notebook PC of claim 17, further comprising at least one second sensor, wherein the first and the second sensors are perpendicularly disposed to each other, whereby detecting a distortion of the sensor board in various orientations.

19. The notebook PC of claim 17, wherein the first sensor is disposed around the periphery of an assembly region, where the sensor board and the spacer are connected.

20. The notebook PC of claim 19, wherein the first sensor is further extended through a gap between the sensor board and the spacer.
